(19) United States
(12) Patent Application Publication
(10) Pub. No.: US 2008/0059722 A1
(43) Pub. Date: Mar. 6, 2008

(54) Handling data processing requests

(75) Inventors: Elodie Charra, Antibe (FR); Nicolas Chaussade, Mouans-Sartoux (FR); Philippe Luc, Nice (FR); Florent Begon, Antibes (FR)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/513,351

(22) Filed: Aug. 31, 2006

(51) Int. Cl. G06F 13/00

(52) U.S. Cl. 711/154

(57) ABSTRACT

A data processing apparatus and method which handle data processing requests is disclosed. The data processing apparatus comprises: reception logic operable to receive, for subsequent issue, a request to perform a processing activity; response logic operable to receive an indication of whether the data processing apparatus is currently able, if the request was issued, perform the processing activity in response to that issued request; and optimisation logic operable, in the event that the response logic indicates that the data processing apparatus would be currently unable to perform the processing activities in response to the issued request, to alter pending requests received by the reception logic to improve the performance of the data processing apparatus. Accordingly, the time available whilst waiting for unit to become available can be utilised to analyse the pending requests and to optimize or alter these requests in some way in order to subsequently improve the performance of the data processing apparatus. Hence, once the component is then able to deal with the altered requests, the altered requests will then enable the data processing apparatus to operate more efficiently than had the original requests been used.

### FIELD OF THE INVENTION

The present invention relates to a data processing apparatus and method which handle data processing requests.

### BACKGROUND OF THE INVENTION

Data processing and methods are known. In a typical data processing apparatus there may be provided a processor core. Typically, other components of the data processing apparatus will be arranged to deal with data processing requests from the core as quickly as possible in order to ensure that the core performs optimally. For example, components of the data processing apparatus will typically endeavour, whenever possible, to accept every request issued by the processing core in order to prevent the processor core from stalling. Accordingly, these components will typically be configured to try to accept and respond as quickly as possible to these requests.

However, in some circumstances, unexpected situations may occur in response to these requests. Accordingly, it is desired to provide an improved technique for handling data processing requests.

### SUMMARY OF THE INVENTION

According to a first aspect of the present invention, there is provided a data processing apparatus comprising: reception logic operable to receive, for subsequent issue, a request to perform a processing activity; response logic operable to receive an indication of whether the data processing apparatus is currently able, if the request was issued, perform the processing activity in response to that issued request; and optimisation logic operable, in the event that the response logic indicates that the data processing apparatus would be currently unable to perform the processing activities in response to the issued request, to alter pending requests received by the reception logic to improve the performance of the data processing apparatus.

The present invention recognizes that whilst logic can be provided to receive requests as quickly as possible in order to ensure that the performance of the unit making the request is not compromised, it may be that other components of the data processing apparatus are currently unable to perform the processing activities the subject of those requests. Hence, the requests could just remain pending and only then issued when the data processing apparatus is able to respond to the requests.

Hence, the present invention provides optimization logic which determines whether the data processing apparatus is unable to currently perform the processing activity and, if so, reviews the pending requests to see whether they can be altered in some way to assist the subsequent data processing activities of the data processing apparatus. In this way, it can be seen that instead of doing nothing whilst the requests are pending, this time can be utilised to analyse the pending requests and to optimize or alter these requests in some way in order to improve the performance of the data processing apparatus. In this way, once the data processing apparatus is then able to deal with the altered requests, the altered requests will then cause the data processing apparatus to operate more efficiently than had it responded to the original requests.

In one embodiment, the optimisation logic is operable to store the altered pending requests whilst the response logic indicates that the data processing apparatus would be unable to perform the data processing activities in response to the pending requests.

Accordingly, the altered pending requests are stored by the reception logic until the data processing apparatus is able to perform the data processing activities in response to the pending requests.

In one embodiment, the requests are issued by a data processing unit and the optimisation logic is operable to alter pending requests to reduce the likelihood of the data processing unit stalling.

In the event that the requests are issued by a data processing unit, the pending requests are altered in order to reduce the probability that the data processing unit will stall.

In one embodiment, the requests are issued by a processor core and the optimisation logic is operable to alter pending requests to reduce the likelihood of the processor core stalling.

In one embodiment, the optimisation logic is operable to alter pending requests to reduce the number of data processing activities required to be performed by the data processing apparatus.

By reducing the number of data processing activities to be performed by the data processing apparatus the performance of the data processing apparatus can be improved.

In one embodiment, the optimisation logic operable, in the event that the response logic indicates that a component of the data processing apparatus would be currently unable to perform the processing activities in response to the issued request, to alter pending requests received by the reception logic intended for that component to reduce the number of pending requests to be issued to that component.

Accordingly, when an indication is provided that a particular component will be unable to perform the data processing activity, the pending requests stored by the reception logic for that particular component are altered in order to reduce the number of pending requests intended for that component.

In one embodiment, the optimisation logic is operable, in the event that the response logic indicates that activity on a bus of the data processing apparatus is such that the bus is unable to receive an issued request, to alter pending requests received by the reception logic to reduce the number of requests to be issued to that bus.

Accordingly, in the event that the activity of the bus is such that it is unable to receive an issued request, pending requests stored by the reception logic are altered in order to reduce the number of requests which need to be issued to that bus.

In one embodiment, the optimisation logic is operable, in the event that the response logic indicates that a bus of the data processing apparatus currently has insufficient bandwidth to support the processing activities in response to the issued request, to alter pending requests received by the reception logic to reduce traffic on that bus.

Hence, in the event that insufficient bandwidth exists on the bus to support the processing activities, the pending requests are altered in order to reduce the traffic load on that bus.

In one embodiment, the optimisation logic is operable to alter pending requests to reduce the number of data processing activities required to be performed by the data processing apparatus.

In one embodiment, the request comprises a data access request to perform a data access activity and the optimisation logic is operable to alter pending data access requests.

Hence, when the request is a data access request to perform data access activities, the optimization logic is operable to alter those pending data access requests.

In one embodiment, the optimisation logic is operable to combine pending data access requests.

Hence, the pending data access requests may be altered by combining a number of those data access requests together to form a single data access request. In this way, it will be appreciated that the number of requests may be reduced.

In one embodiment, the optimisation logic is operable to merge pending data access requests to a common cache line.

Accordingly, the pending data access requests may be merged when those pending requests relate to the same cache line.

In one embodiment, the optimisation logic is operable to generate a multiple data access request from a plurality of pending data access requests.

Accordingly, a plurality of pending data access requests may be combined and a single multiple data access request generated to replace them.

In one embodiment, the response logic is operable to receive the indication of whether a component of the data processing apparatus which would be utilised to perform the data access activity is currently performing a different data access activity.

Hence, the indication that the component is unable to perform the requested activity may be that the component is busy since it is currently performing a different data access activity.

In one embodiment, the request comprises a data processing request to perform a data processing activity and the optimisation logic is operable to alter pending data processing requests.

Accordingly, when the request comprises a request to perform a data processing activity the optimization logic may optimize those pending data processing requests.

In one embodiment, the optimisation logic is operable to disregard inessential pending data processing requests.

Accordingly, non-essential pending data processing requests may be disregarded if disregarding these requests will improve the performance of the data processing apparatus.

In one embodiment, the optimisation logic is operable to cancel pending pre-load requests.

Accordingly, requests such as pre-load requests may be cancelled since these requests may not actually be essential to be performed and they may prevent more essential requests being performed which may impact on the overall performance of the data processing apparatus. By cancelling these pre-load requests the performance of the data processing apparatus in more circumstances can be improved.

In one embodiment, the optimisation logic is operable to overwrite a pending pre-load request.

Accordingly, rather than cancelling subsequent pre-load requests, any existing pre-load request may simply be replaced with a subsequent pre-load request.

In one embodiment, the optimisation logic is operable to prevent the reception logic from storing further pre-load requests when a pending pre-load request exists.

Hence, rather than overwriting the pending pre-load requests, any further pre-load request may be prevented from being stored in the event that a pending pre-load request still exists.

According to a second aspect of the present invention there is provided a data processing method comprising the steps of: receiving, for subsequent issue, a request to perform a processing activity; receiving an indication of whether a data processing apparatus is currently able, if the request was issued, perform the processing activity in response to that issued request; and in the event that the receiving step indicates that the data processing apparatus would be currently unable to perform the processing activities in response to the issued request, altering pending requests to improve the performance of the data processing apparatus.

According to a third aspect of the present invention, there is provided a processing unit comprising: reception means for receiving, for subsequent issue, a request to perform a processing activity; response means for receiving an indication of whether the data processing apparatus is currently able, if the request was issued, perform the processing activity in response to that issued request; and optimisation means for, in the event that the response means indicates that the data processing apparatus would be currently unable to perform the processing activities in response to the issued request, altering pending requests received by the reception means to improve the performance of a data processing apparatus.

### BRIEF DESCRIPTION OF THE DRAWINGS

The present invention will be described further, by way of example only, with reference to preferred embodiments thereof as illustrated in the accompanying drawings, in which;

FIG. 1 illustrates schematically a data processing apparatus according to one embodiment;

FIG. 2 is a flow chart illustrating the operation of the data processing apparatus illustrated in FIG. 1.

### DESCRIPTION OF THE EMBODIMENTS

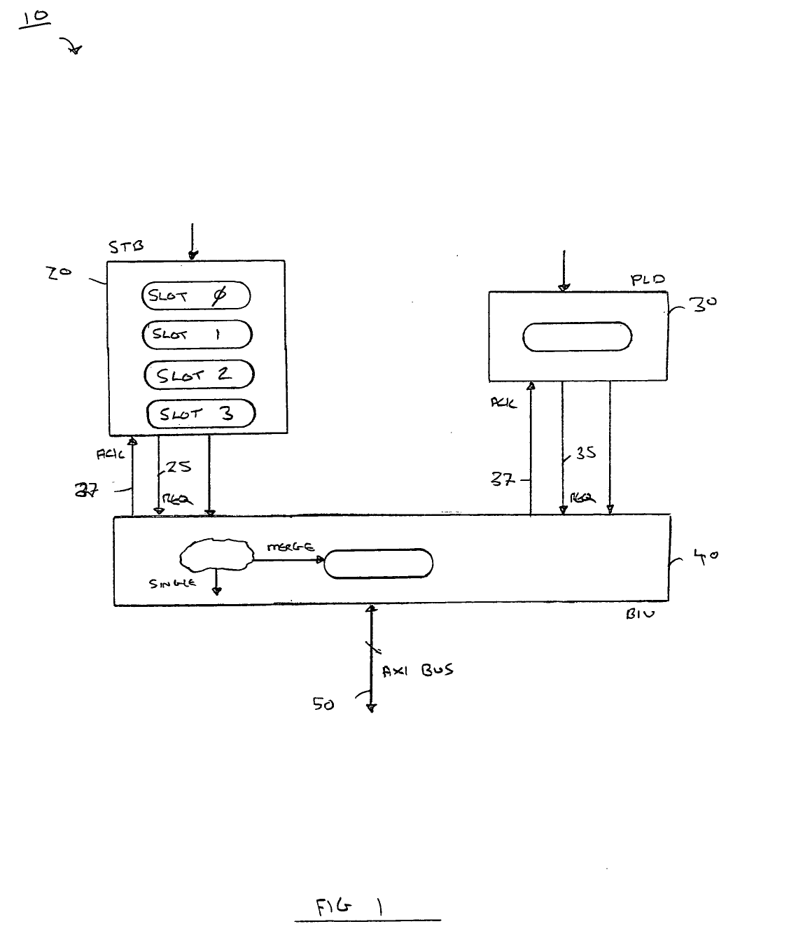

FIG. 1 illustrates schematically components of a data processing apparatus, generally 10, according to one embodiment. A store buffer, 20 is provided which receives write requests issued by a processor core (not shown). Also provided is a pre-load unit 30 which receives pre-load instructions from the processor core. The store buffer 20 and the pre-load unit 30 are both coupled with a bus interface unit 40. The bus interface unit 40 is coupled with an AXI bus 50 which supports data communication with other components (not shown) of the data processing apparatus 10.

The store buffer 20 stores write requests issued by the processor core prior to those requests being issued to the bus interface unit 40. In this way, the write requests may be received from the processor core and stored temporarily in the store buffer 20 to enable the processor core to continue its operations despite the write request not having yet been completed. It will be appreciated that this helps to decouple the operation of the processor core from that of the bus interface unit 40 in order to prevent the processor core from stalling which enables the processor core to operate more efficiently.

Similarly, the pre-load unit 30 can store pre-load requests issued by the processor core prior to these being issued to the bus interface unit 40. Once again, this enables the processor core to continue its operations even when the pre-load request have not yet been completed.

It will be appreciated that other buffers or units may be provided which can receive requests from a processor core or other data processing unit prior to issuing those request for execution to enable those units to operate as sufficiently as possible.

Once a request has been received by the store buffer 20 or the pre-load unit 30 then that unit will request that the bus interface unit 40 provides access to the AXI bus 50 by asserting a request signal on the lines 25 or 35 respectively.

In the event that there is currently no activity on the AXI bus 50 then the bus interface unit 40 will arbitrate between request signals provided by different units. Once the arbitration has been made, generally based on relative priorities assigned to requests from different units, an acknowledge signal is provided over the path 27 or 37, dependent on which unit is allocated access to the AXI bus 50. Should a unit be granted immediate access to the AXI bus 50 on receipt of a request then that request may be passed straight to the bus interface unit 40 without necessarily needing to be stored by that unit. However, it will be appreciated that it would also be possible to always store each request received by a unit and then indicate that the request has been issued and can be overwritten in the unit once it has been accepted by the bus interface unit 40. Accordingly, in the event that the AXI bus 50 is available immediately or shortly after each request has been received by the store buffer 20 then these requests are can be passed straight to the bus interface unit 40 for transmission over the AXI bus 50 without any optimization. Similarly, in the event that the AXI bus 50 is readily available then any pre-load instructions provided to the pre-load unit 30 may be rapidly forwarded to the bus interface unit 40 for transmission over the AXI bus 50 without modification.

To illustrate this, consider the following sequence of requests issued by the processor core to the store buffer 20 when the AXI bus 50 has high availability: STR@0; STR@0+8; and STB@0+1.

The store buffer 20 will assign the STR@0 request to slot 0. Then, the store buffer 20 will drain the STR@0 request to the bus interface unit 40. This will occur before the STR@0+8 request has been assigned to slot 1 and linked with slot 0. Then, the store buffer 20 will drain the STR@0+8 request to the bus interface unit 40. Following this, the STB@0+1 request is received by the store buffer 20. This will be assigned to slot 2 since the STR@0 request has already been drained and so there is no opportunity to merge these requests together in slot 1.

Accordingly, because the bus interface unit 40 accepts requests from the store buffer 20 straight away due to their being availability on the AXI bus 50, the link and merge features of the store buffer are not utilized. Accordingly, when the AXI bus 50 has high availability, it will also receive the requests STR@0, STR@0+8 and STB@0+1.

Similarly, in the event that the pre-load unit 30 receives the instructions PLD_{A}, PLD_{B} and PLD_{C} then these instructions will each be provided to the pre-load unit 30 and drained quickly to the bus interface unit 40 for transmission over the AXI bus 50 before the next pre-load instruction is received by the pre-load unit 30. Accordingly, the AXI bus 50 also receives the instructions PLD_{A}, PLD_{B} and PLD_{C}.

However, in the event that the availability of the AXI bus 50 is low, typically due to high levels of activity on the AXI bus 50 then optimization of the pending requests within the store buffer 20 and the pre-load unit 30 will occur.

Hence, if the same sequence of instructions mentioned above are provided to the store buffer 20 when the availability of the AXI bus 50 is low, the bus interface unit 40 will indicate to the store buffer 20 that the AXI bus 50 is unable to accept requests so the requests are then held in the store buffer 20 and the merge and link capabilities of the store buffer 20 can be utilized.

Accordingly, the instruction STR@0 is stored in slot 0. Then, the instruction STR@0+8 is received, stored in slot 1 and linked with slot 0. When the request STB@0+1 is received, this is then merged into slot 0.

Hence, when the bus interface unit 40 then indicates that the AXI bus 50 is able to receive requests, the store buffer 20 will send a request STM4@0 to the bus interface unit 40 for transmission over the AXI bus 50 in place of the three separate requests. It will be appreciated that the transmission of a single STM4 instruction rather than multiple STR or STB instructions provides for more efficient use of the AXI bus 50 when its availability is low.

Similarly, if the same sequence of instructions mentioned above are provided to the pre-load unit 30 when the availability of the AXI bus 50 is low, optimisation of the instructions can occur in the pre-load unit 30.

Accordingly, the pre-load unit 30 will receive the PLD_{A} instruction and this will be stored therein. Thereafter, the PLD_{B} instruction will be received and this will overwrite the PLD_{A} instruction so that the PLD_{A} instruction is disregarded. Then, if the PLD_{C} instruction is received before the PLD_{B} instruction is drained to the bus interface unit 40, this PLD_{C} instruction will overwrite the PLD_{B} instruction. Thereafter, the PLD_{C} instruction will be drained to the bus interface unit 40 once access to the AXI bus 50 has been allocated to the pre-load unit 30.

Hence, it can be seen that pending pre-load instructions are dropped when a more recent pre-load instruction is received. By cancelling the earlier pre-load instruction, the number of pre-load instructions which need to be issued to the AXI bus 50 is reduced. Reducing the number of pre-load instructions to be sent to the AXI bus 50 is advantageous since this reduces the load on an already busy AXI bus 50. This then frees the AXI bus 50 to perform more immediately critical transactions which may be required by the processor core. The pre-load instructions may readily be cancelled since these instructions are essentially speculative and the resultant data may not have been used anyway.

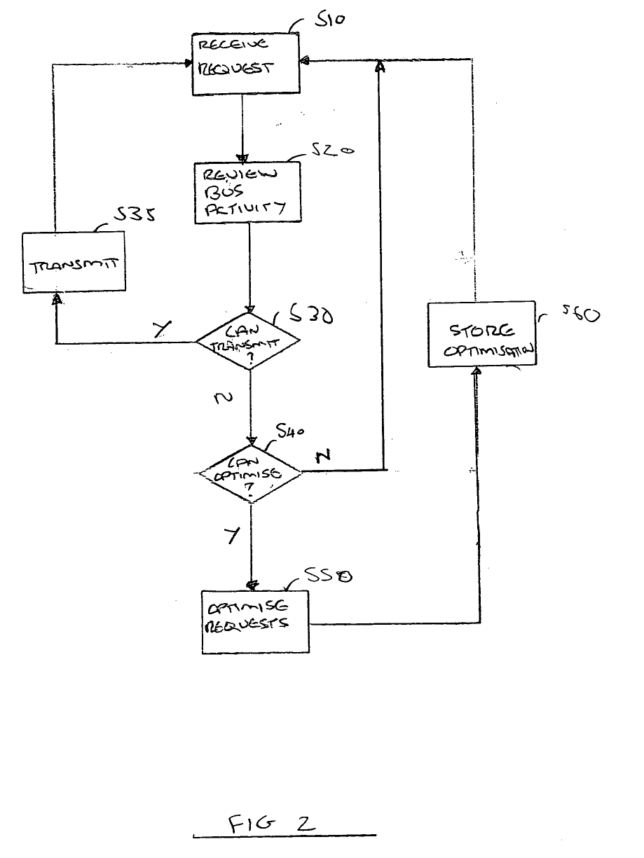

FIG. 2 is a flow chart illustrating in more detail the operation of the store buffers 20 and the pre-load unit 30.

At step S10, the unit receives an instruction or request.

At step S20, the availability of the AXI bus 50 is reviewed.

At step S30, in the event that AXI bus 50 is available, the instruction or request is transmitted over the AXI bus 50 at step S35 and processing returns to step S10. However, in the event that the AXI bus 50 is unavailable then processing proceeds to step S40.

At step S40, a determination is made whether it is possible to optimise the received instruction or request with any pending instruction or requests. In the event that no optimization is possible then processing returns to step S10. However, in the event that it is determined that optimization is possible then processing proceeds to step S50. At step S50, pending requests are optimized. Thereafter, at step S60, those optimizations are stored and processing then returns to step S10.

In this way, it can be seen that the units determine whether a component of the data processing apparatus, such as the AXI bus 50, is unable to currently support the processing activity and, if so, reviews the pending requests to see whether they can be altered in some way to assist the subsequent data processing activities. Accordingly, the time available whilst waiting for unit to become available can be utilised to analyse the pending requests and to optimize or alter these requests in some way in order to subsequently improve the performance of the data processing apparatus. Hence, once the component is then able to deal with the altered requests, the altered requests will then enable the data processing apparatus to operate more efficiently than had the original requests been used.

Although a particular embodiment of the invention has been described herein, it will be apparent that the invention is not limited thereto, and that many modifications and additions may be made within the scope of the invention. For example, various combinations of features of the following depending claims could be made with features of the independent claims without departing from the scope of present invention.

We claim:

1. A data processing apparatus comprising:
reception logic operable to receive, for subsequent issue, a request to perform a processing activity;
response logic operable to receive an indication of whether said data processing apparatus is currently able, if said request was issued, perform said processing activity in response to that issued request; and
optimisation logic operable, in the event that said response logic indicates that said data processing apparatus would be currently unable to perform said processing activities in response to said issued request, to alter pending requests received by said reception logic to improve the performance of said data processing apparatus.

2. The data processing apparatus of claim 1, wherein said optimisation logic is operable to store said altered pending requests whilst said response logic indicates that said data processing apparatus would be unable to perform said data processing activities in response to said pending requests.

3. The data processing apparatus of claim 1, wherein said requests are issued by a data processing unit and said optimisation logic is operable to alter pending requests to reduce the likelihood of said data processing unit stalling.

4. The data processing apparatus of claim 1, wherein said requests are issued by a processor core and said optimisation logic is operable to alter pending requests to reduce the likelihood of said processor core stalling.

5. The data processing apparatus of claim 1, wherein said optimisation logic is operable to alter pending requests to reduce the number of data processing activities required to be performed by said data processing apparatus.

6. The data processing apparatus of claim 1, wherein said optimisation logic operable, in the event that said response logic indicates that a component of said data processing apparatus would be currently unable to perform said processing activities in response to said issued request, to alter pending requests received by said reception logic intended for that component to reduce the number of pending requests to be issued to that component.

7. The data processing apparatus of claim 1, wherein said optimisation logic is operable, in the event that said response logic indicates that activity on a bus of said data processing apparatus is such that said bus is unable to receive an issued request, to alter pending requests received by said reception logic to reduce the number of requests to be issued to that bus.

8. The data processing apparatus of claim 1, wherein said optimisation logic is operable, in the event that said response logic indicates that a bus of said data processing apparatus currently has insufficient bandwidth to support said processing activities in response to said issued request, to alter pending requests received by said reception logic to reduce traffic on that bus.

9. The data processing apparatus of claim 1, wherein said optimisation logic is operable to alter pending requests to reduce the number of data processing activities required to be performed by said data processing apparatus.

10. The data processing apparatus of claim 1, wherein said request comprises a data access request to perform a data access activity and said optimisation logic is operable to alter pending data access requests.

11. The data processing apparatus of claim 10, wherein said optimisation logic is operable to combine pending data access requests.

12. The data processing apparatus of claim 10, wherein said optimisation logic is operable to merge pending data access requests to a common cache line.

13. The data processing apparatus of claim 10, wherein said optimisation logic is operable to generate a multiple data access request from a plurality of pending data access requests.

14. The data processing apparatus of claim 10, wherein said response logic is operable to receive said indication of whether a component of said data processing apparatus which would be utilised to perform said data access activity is currently performing a different data access activity.

15. The data processing apparatus of claim 1, wherein said request comprises a data processing request to perform a data processing activity and said optimisation logic is operable to alter pending data processing requests.

16. The data processing apparatus of claim 15, wherein said optimisation logic is operable to disregard inessential pending data processing requests.

17. The data processing apparatus of claim 15, wherein said optimisation logic is operable to cancel pending pre-load requests.

18. The data processing apparatus of claim 15, wherein said optimisation logic is operable to overwrite a pending pre-load request.

19. The data processing apparatus of claim 15, wherein said optimisation logic is operable to prevent said reception logic from storing further pre-load requests when a pending pre-load request exists.

20. A data processing method comprising the steps of:
receiving, for subsequent issue, a request to perform a processing activity;
receiving an indication of whether a data processing apparatus is currently able, if said request was issued, perform said processing activity in response to that issued request; and
in the event that said receiving step indicates that said data processing apparatus would be currently unable to perform said processing activities in response to said issued request, altering pending requests to improve the performance of said data processing apparatus.

21. A processing unit comprising:
reception means for receiving, for subsequent issue, a request to perform a processing activity;
response means for receiving an indication of whether said data processing apparatus is currently able, if said request was issued, perform said processing activity in response to that issued request; and
optimisation means for, in the event that said response means indicates that said data processing apparatus would be currently unable to perform said processing activities in response to said issued request, altering pending requests received by said reception means to improve the performance of a data processing apparatus.
